(19) United States
(12) Patent Application Publication
(10) Pub. No.: US 2026/0196722 A1
(43) Pub. Date: Jul. 9, 2026

(54) ANTENNA SYSTEM FOR OPTIMIZING ANTENNA PATTERN

(71) Applicant: ASUSTeK COMPUTER INC., Taipei (TW)

(72) Inventors: Chien-Ming Hsu, Taipei (TW); Chun-Chieh Su, Taipei (TW); Sung-Mao Liao, Taipei (TW)

(21) Appl. No.: 19/416,027

(22) Filed: Dec. 11, 2025

(30) Foreign Application Priority Data
Jan. 6, 2025 (TW) 114100519

(51) Int. Cl. H01Q 3/24; H01Q 5/307; H01Q 5/50

(52) U.S. Cl. CPC H01Q 3/247; H01Q 5/307; H01Q 5/50

(57) ABSTRACT

An antenna system for optimizing an antenna pattern includes: an open circuit between a first antenna metal portion and a second antenna metal portion; a first feeding contact is connected to the first antenna metal portion, and a second feeding contact is connected to the second antenna metal portion; a first ground contact is connected to the first antenna metal portion, and a second ground contact is connected to the second antenna metal portion; a first matching circuit is connected to the first feeding contact, and a second matching circuit is electrically connected to the second feeding contact; a plurality of first ground paths is connected to the first feeding contact; and one end of a first switch circuit is connected between the first feeding contact and the first matching circuit, and the other end of the first switch circuit is connected to the plurality of first ground paths.

### CROSS-REFERENCE TO RELATED APPLICATION

This application claims the priority benefit of Taiwan Application Serial No. 114100519, filed on January 6, 2025. The entirety of the above-mentioned patent application is hereby incorporated by reference herein and made a part of specification.

### BACKGROUND OF THE INVENTION

### Field of the Invention

The disclosure relates to an antenna system that dynamically switches an antenna pattern to optimize the antenna pattern.

### Description of the Related Art

For an existing wireless communication electronic product, such as a mobile phone, a quantity of antennas built in the mobile phone increases, but space available for antenna design decreases, making every inch of space valuable. In previous antenna design, if two adjacent antennas, that is, a first antenna and a second antenna, are used, the first antenna is usually responsible for signal transmitting and receiving of a first communication module, and the second antenna is responsible for signal transmitting and receiving of a second communication module. However, in a limited space environment, it is impossible to enhance and switch a dynamic pattern without changing antenna space. Therefore, for an electronic product with limited space but most functions needing to be supported, it is difficult to further improve the antenna pattern in existing technologies.

### BRIEF SUMMARY OF THE INVENTION

The disclosure provides an antenna system for optimizing an antenna pattern, including a first antenna metal portion, a second antenna metal portion, a first feeding contact, a second feeding contact, a first ground contact, a second ground contact, a first matching circuit, a second matching circuit, a plurality of first ground paths, and a first switch circuit. In the antenna system for optimizing an antenna pattern, a gap is between the first antenna metal portion and the second antenna metal portion, to cause an open circuit to be between the first antenna metal portion and the second antenna metal portion. The first feeding contact is electrically connected to the first antenna metal portion, and the second feeding contact is electrically connected to the second antenna metal portion. The first ground contact is electrically connected to the first antenna metal portion, and is farther away from the open circuit than the first feeding contact. The second ground contact is electrically connected to the second antenna metal portion, and is farther away from the open circuit than the second feeding contact. The first matching circuit is electrically connected to the first feeding contact, and the second matching circuit is electrically connected to the second feeding contact. The plurality of first ground paths is connected to the first feeding contact. One end of the first switch circuit is electrically connected between the first feeding contact and the first matching circuit, and the other end of the first switch circuit is electrically connected to the plurality of first ground paths to selectively conduct the first feeding contact to one of the plurality of first ground paths.

In summary, the disclosure provides the antenna system for optimizing an antenna pattern. In a limited and compact antenna design environment, impedance and a current path of an antenna are changed by switching the ground paths through the switch circuit, to dynamically switch the antenna pattern, and further to expand and enhance a range of the antenna pattern. Therefore, in the disclosure, an antenna reception range is increased and antenna performance is enhanced by optimizing the antenna pattern.

### BRIEF DESCRIPTION OF THE DRAWINGS

FIG. 1 is a schematic diagram of an architecture of an antenna system for optimizing a second antenna metal portion according to an embodiment of the disclosure.

FIG. 2 is a schematic diagram of a circuit block of an antenna system for optimizing a second antenna metal portion according to an embodiment of the disclosure.

FIG. 3 is a schematic diagram of an architecture of an antenna system for optimizing a first antenna metal portion according to an embodiment of the disclosure.

FIG. 4 is a schematic diagram of a circuit block of an antenna system for optimizing a first antenna metal portion according to an embodiment of the disclosure.

FIG. 5 is a schematic diagram of an architecture of an antenna system for optimizing a first antenna metal portion and a second antenna metal portion according to an embodiment of the disclosure.

FIG. 6 is a schematic diagram of a circuit block of an antenna system for optimizing a first antenna metal portion and a second antenna metal portion according to an embodiment of the disclosure.

FIG. 7 is a schematic diagram of an actual architecture of an antenna system for optimizing a first antenna metal portion according to an embodiment of the disclosure.

FIG. 8 is a schematic diagram of a circuit block of an antenna system being switched to a second open circuit ground path according to an embodiment of the disclosure.

FIG. 9 is a schematic diagram of a circuit block of an antenna system being switched to a zero-ohm resistor ground path according to an embodiment of the disclosure.

FIG. 10 is an XY-plane pattern view of an antenna system for optimizing a first antenna metal portion at an operating frequency band Wi-Fi 5G according to an embodiment of the disclosure.

FIG. 11 is an XZ-plane pattern view of an antenna system for optimizing a first antenna metal portion at an operating frequency band Wi-Fi 5G according to an embodiment of the disclosure.

FIG. 12 is a YZ-plane pattern view of an antenna system for optimizing a first antenna metal portion at an operating frequency band Wi-Fi 5G according to an embodiment of the disclosure.

FIG. 13 is a schematic diagram of simulation of a reflection coefficient curve (S₁₁ parameter) generated by an antenna system at an operating frequency band Wi-Fi 5G according to the disclosure.

FIG. 14 is a schematic diagram of simulation of radiation efficiency generated by an antenna system at an operating frequency band Wi-Fi 5G according to the disclosure.

### DETAILED DESCRIPTION OF THE EMBODIMENTS

The following describes embodiments of the disclosure with reference to related drawings. In addition, some components or structures are omitted in the drawings of the embodiments to clearly show technical features of the disclosure. In these drawings, same reference numerals represent same or similar components or circuits. It should be understood that although the terms "first", "second", and the like are used herein to describe various components, parts, regions, or functions, these components, parts, regions, and/or functions should not be limited by these terms. These terms are only used to distinguish one component, part, region, or function from another component, part, region, or function.

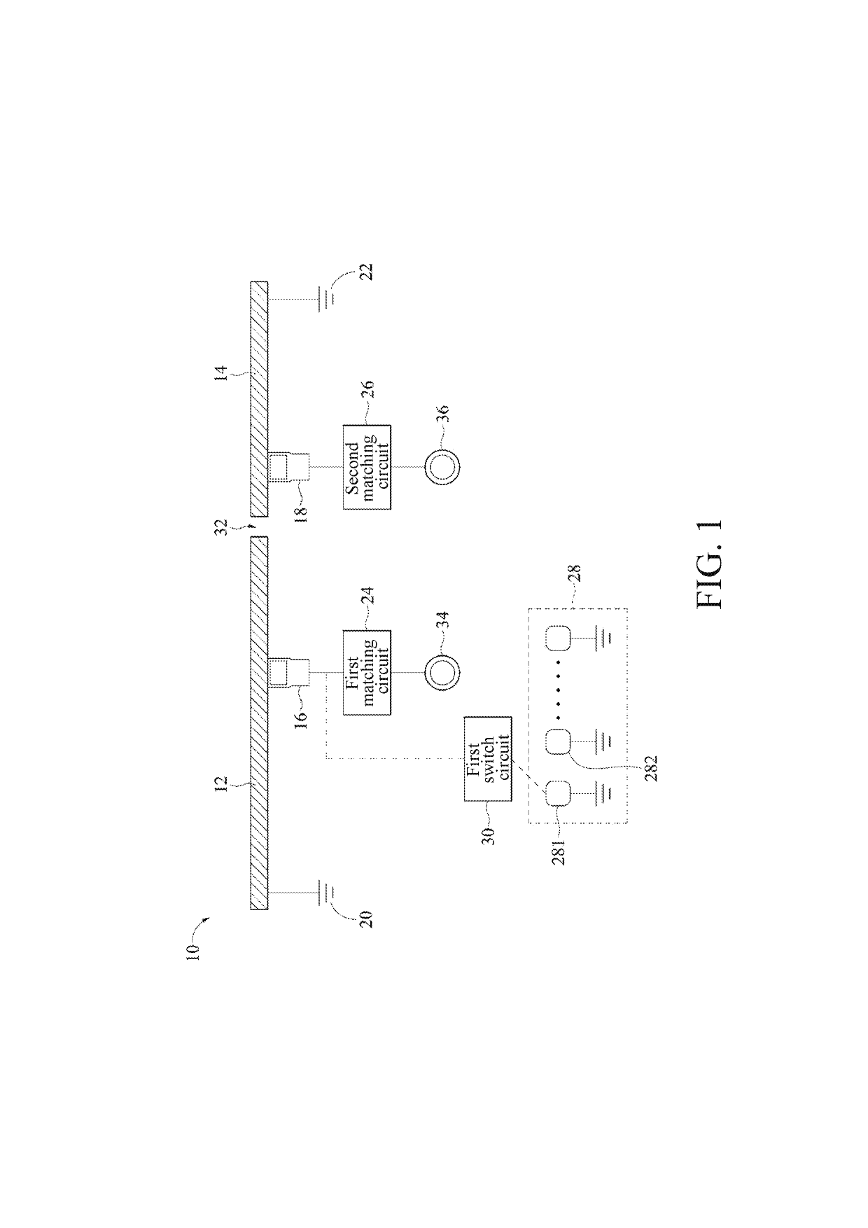

Refer to FIG. 1. An antenna system 10 for optimizing an antenna pattern includes a first antenna metal portion 12, a second antenna metal portion 14, a first feeding contact 16, a second feeding contact 18, a first ground contact 20, a second ground contact 22, a first matching circuit 24, a second matching circuit 26, a plurality of first ground paths 28, and a first switch circuit 30. In the antenna system 10 for optimizing an antenna pattern, the first antenna metal portion 12 is located at a side of the second antenna metal portion 14. A gap is between the first antenna metal portion 12 and the second antenna metal portion 14, to cause an open circuit 32 to be between the first antenna metal portion 12 and the second antenna metal portion 14, so as to use the first antenna metal portion 12 and the second antenna metal portion 14 as radiators. The first feeding contact 16 is electrically connected to the first antenna metal portion 12 and is close to the open circuit 32. The second feeding contact 18 is electrically connected to the second antenna metal portion 14 and is close to the open circuit 32. The first ground contact 20 is electrically connected to the first antenna metal portion 12 and is farther away from the open circuit 32 than the first feeding contact 16. The second ground contact 22 is electrically connected to the second antenna metal portion 14 and is farther away from the open circuit 32 than the second feeding contact 18. One end of the first matching circuit 24 is electrically connected to the first feeding contact 16, and the other end of the first matching circuit 24 is electrically connected to a first signal source 34. One end of the second matching circuit 26 is electrically connected to the second feeding contact 18, and the other end of the second matching circuit 26 is electrically connected to a second signal source 36. The plurality of first ground paths 28 is connected to the first feeding contact 16. The plurality of first ground paths 28 includes a first open circuit ground path 281 and at least one first passive component ground path 282. In addition, the first open circuit ground path 281 includes an open circuit connected to a ground end, and the first passive component ground path 282 includes a passive component connected to the ground end. In the disclosure, to optimize antenna performance and a pattern range of the second antenna metal portion 14, the first switch circuit 30 is added to the first antenna metal portion 12. One end of the first switch circuit 30 is electrically connected between the first feeding contact 16 and the first matching circuit 24, and the other end of the first switch circuit 30 is electrically connected to the plurality of first ground paths 28. The first switch circuit 30 selectively conducts the first feeding contact 16 to one of the plurality of first ground paths 28, to switch the first ground path 28 through the first switch circuit 30.

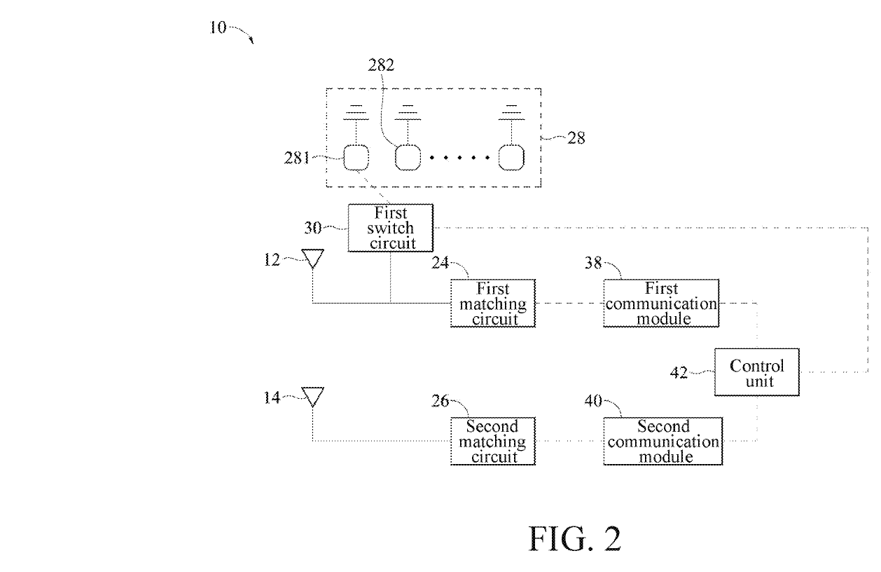

Refer to FIG. 1 and FIG. 2. The first matching circuit 24 is further electrically connected to a first communication module 38, so that the first communication module 38 is used as the first signal source 34. The first antenna metal portion 12 is responsible for signal transmitting and receiving of the first communication module 38. The second matching circuit 26 is further electrically connected to a second communication module 40, so that the second communication module 40 is used as the second signal source 36. The second antenna metal portion 14 is responsible for signal transmitting and receiving of the second communication module 40. In addition, the first switch circuit 30, the first communication module 38, and the second communication module 40 are electrically connected to a control unit 42, such as a central processing unit (CPU), to control the first switch circuit 30, the first communication module 38, and the second communication module 40 through the control unit 42. When the antenna system 10 in the disclosure transmits and receives signals, and the first communication module 38 and the second communication module 40 are in operation simultaneously, the control unit 42 controls the first switch circuit 30 to selectively conduct the first feeding contact 16 to the first open circuit ground path 281, to maintain normal operation of the first antenna metal portion 12 and the second antenna metal portion 14. When the first communication module 38 is disabled and the second communication module 40 is in operation, the control unit 42 controls the first switch circuit 30 to selectively conduct the first feeding contact 16 to the first passive component ground path 282, to change original impedance or an original current path of the second antenna metal portion 14, to change an antenna pattern to optimize the antenna pattern.

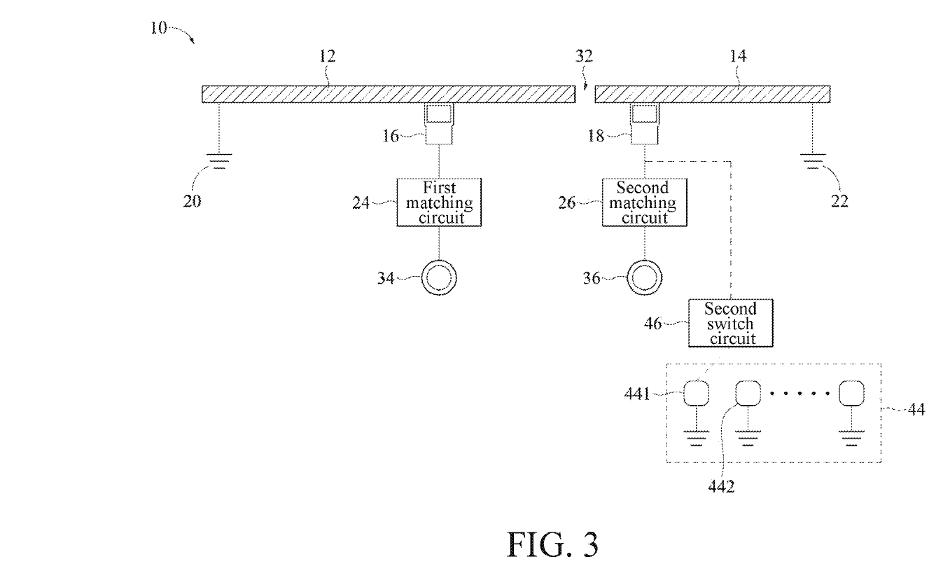

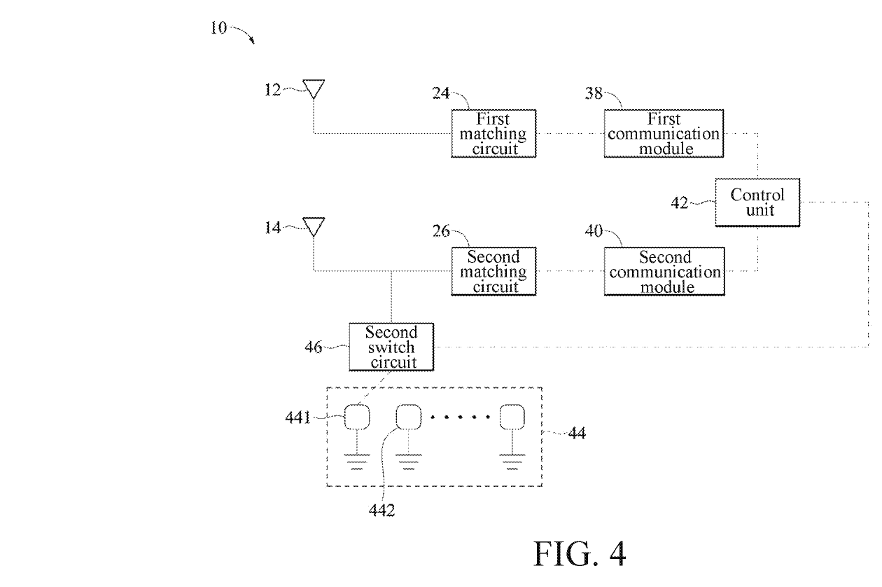

In the disclosure, to optimize antenna performance and a pattern range of the first antenna metal portion 12, a second switch circuit 46 is added to the second antenna metal portion 14. Refer to FIG. 3 and FIG. 4. An antenna system 10 for optimizing an antenna pattern includes a first antenna metal portion 12, a second antenna metal portion 14, a first feeding contact 16, a second feeding contact 18, a first ground contact 20, a second ground contact 22, a first matching circuit 24, a second matching circuit 26, a plurality of second ground paths 44, and a second switch circuit 46. In the antenna system 10, the plurality of second ground paths 44 is connected to the second feeding contact 18. The plurality of second ground paths 44 includes a second open circuit ground path 441 and at least one second passive component ground path 442. In addition, the second open circuit ground path 441 includes an open circuit connected to a ground end, and the second passive component ground path 442 includes a passive component connected to the ground end. One end of the second switch circuit 46 is electrically connected between the second feeding contact 18 and the second matching circuit 26, and the other end of the second switch circuit 46 is electrically connected to the plurality of second ground paths 44. The second switch circuit 46 selectively conducts the second feeding contact 18 to one of the plurality of second ground paths 44, to switch the second ground path 44 through the second switch circuit 46. In addition, the second switch circuit 46, a first communication module 38, and a second communication module 40 are electrically connected to a control unit 42, to control the second switch circuit 46, the first communication module 38, and the second communication module 40 through the control unit 42. Another structure is the same as those of the embodiments shown in FIG. 1 and FIG. 2, and details are not described again herein. When the antenna system 10 in the disclosure transmits and receives signals, and the first communication module 38 and the second communication module 40 are in operation simultaneously, the control unit 42 controls the second switch circuit 46 to selectively conduct the second feeding contact 18 to the second open circuit ground path 441, to maintain normal operation of the first antenna metal portion 12 and the second antenna metal portion 14. When the second communication module 40 is disabled and the first communication module 38 is in operation, the control unit 42 controls the second switch circuit 46 to selectively conduct the second feeding contact 18 to the second passive component ground path 442, to change original impedance or an original current path of the first antenna metal portion 12, to change an antenna pattern to optimize the antenna pattern.

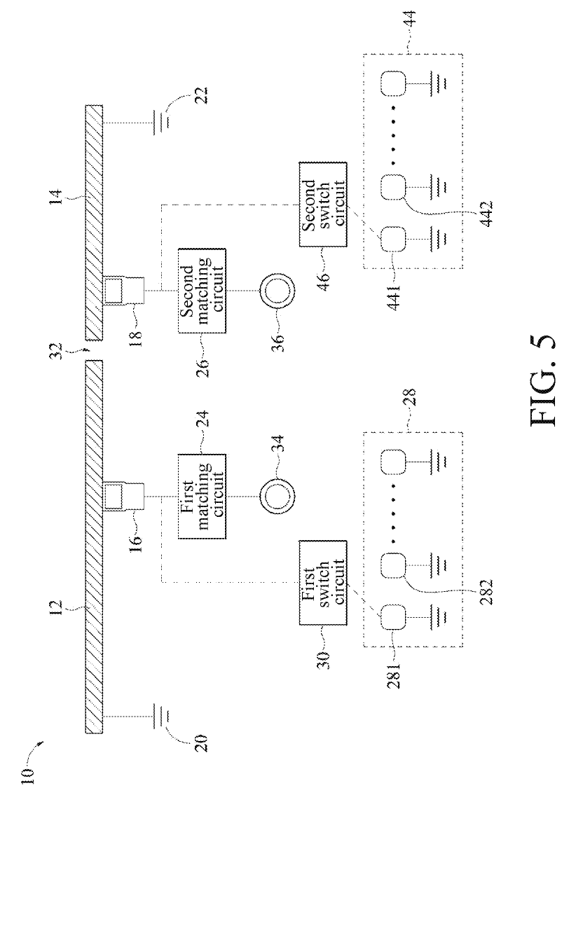

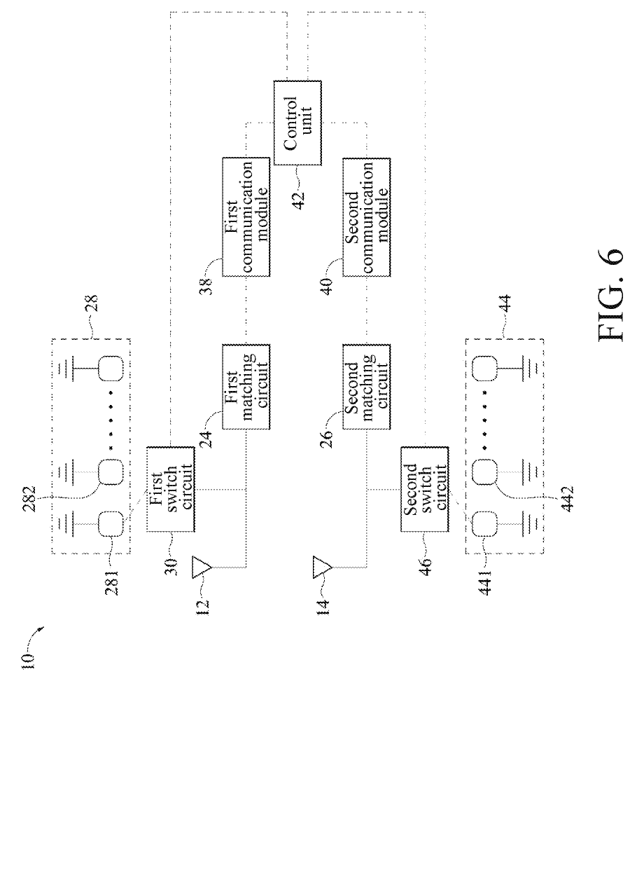

In the disclosure, to simultaneously optimize antenna performance and pattern ranges of the first antenna metal portion 12 and the second antenna metal portion 14, a first switch circuit 30 is further added to the first antenna metal portion 12 and the second switch circuit 46 is further added to the second antenna metal portion 14. Refer to FIG. 5 and FIG. 6. An antenna system 10 for optimizing an antenna pattern includes a first antenna metal portion 12, a second antenna metal portion 14, a first feeding contact 16, a second feeding contact 18, a first ground contact 20, a second ground contact 22, a first matching circuit 24, a second matching circuit 26, a plurality of first ground paths 28, a plurality of second ground paths 44, a first switch circuit 30, and a second switch circuit 46. In the antenna system 10, the plurality of first ground paths 28 is connected to the first feeding contact 16, and the plurality of second ground paths 44 is connected to the second feeding contact 18. The plurality of first ground paths 28 includes a first open circuit ground path 281 and at least one first passive component ground path 282, and the plurality of second ground paths 44 includes a second open circuit ground path 441 and at least one second passive component ground path 442. One end of the first switch circuit 30 is electrically connected between the first feeding contact 16 and the first matching circuit 24, and the other end of the first switch circuit 30 is electrically connected to the plurality of first ground paths 28. The first switch circuit 30 selectively conducts the first feeding contact 16 to one of the plurality of first ground paths 28, to switch the first ground path 28 through the first switch circuit 30. One end of the second switch circuit 46 is electrically connected between the second feeding contact 18 and the second matching circuit 26, and the other end of the second switch circuit 46 is electrically connected to the plurality of second ground paths 44. The second switch circuit 46 selectively conducts the second feeding contact 18 to one of the plurality of second ground paths 44, to switch the second ground path 44 through the second switch circuit 46. In addition, the first switch circuit 30, the second switch circuit 46, a first communication module 38, and a second communication module 40 are electrically connected to a control unit 42, to control the first switch circuit 30, the second switch circuit 46, the first communication module 38, and the second communication module 40 through the control unit 42. Another structure is the same as those of the embodiments shown in FIG. 1 and FIG. 2, and details are not described again herein. When the antenna system 10 in the disclosure transmits and receives signals, and the first communication module 38 and the second communication module 40 are in operation simultaneously, the control unit 42 controls the first switch circuit 30 to selectively conduct the first feeding contact 16 to the first open circuit ground path 281, and control the second switch circuit 46 to selectively conduct the second feeding contact 18 to the second open circuit ground path 441, to maintain normal operation of the first antenna metal portion 12 and the second antenna metal portion 14. When the first communication module 38 is disabled and the second communication module 40 is in operation, the control unit 42 controls the first switch circuit 30 to selectively conduct the first feeding contact 16 to the first passive component ground path 282, to optimize an antenna pattern of the second antenna metal portion 14. When the second communication module 40 is disabled and the first communication module 38 is in operation, the control unit 42 controls the second switch circuit 46 to selectively conduct the second feeding contact 18 to the second passive component ground path 442, to optimize an antenna pattern of the first antenna metal portion 12.

In an embodiment, the first antenna metal portion 12 is selected from a wireless wide area network (WWAN) antenna, a Wi-Fi antenna, a wireless local area network (WLAN) antenna, a global positioning system (GPS) antenna, or an ultra-wideband (UWB) antenna. The second antenna metal portion 14 is also selected from a wireless wide area network (WWAN) antenna, a Wi-Fi antenna, a wireless local area network (WLAN) antenna, a global positioning system (GPS) antenna, or an ultra-wideband (UWB) antenna.

In an embodiment, the at least one first passive component ground path 282 and the at least one second passive component ground path 442 are respectively selected from a zero-ohm resistor ground path, a resistor ground path, an inductor ground path, a capacitor ground path, or a resistor-inductor-capacitor combination ground path.

In an embodiment, the first switch circuit 30 and the second switch circuit 46 are respectively selected from a single-pole four-throw (SP4T) switch, at least one single-pole double-throw (SPDT) switch, or a plurality of single-pole single-throw (SPST) switches, so that the first switch circuit 30 is selected as an appropriate switch type based on a quantity of first ground paths 28, and the second switch circuit 46 is selected as an appropriate switch type based on a quantity of second ground paths 44.

In an embodiment, refer to FIG. 1, FIG. 3, and FIG. 5. The first antenna metal portion 12 and the second antenna metal portion 14 are metal frame antennas of an electronic device, but are not limited thereto. The first antenna metal portion 12 and the second antenna metal portion 14 vary depending on application of the antenna system 10, such as a flexible printed circuit (FPC) antenna, a laser direct structuring (LDS) antenna, or a steel antenna, but the disclosure is not limited thereto.

In an embodiment, the foregoing electronic device is a mobile phone, a personal digital assistant, a tablet computer, a laptop computer, or the like, but the disclosure is not limited thereto. Any electronic device with a mobile communication function is covered by the disclosure.

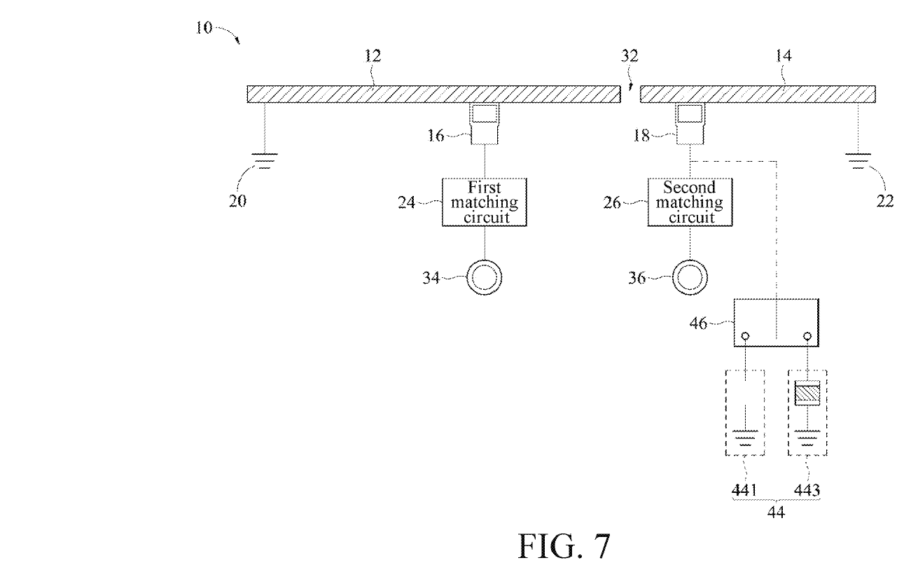

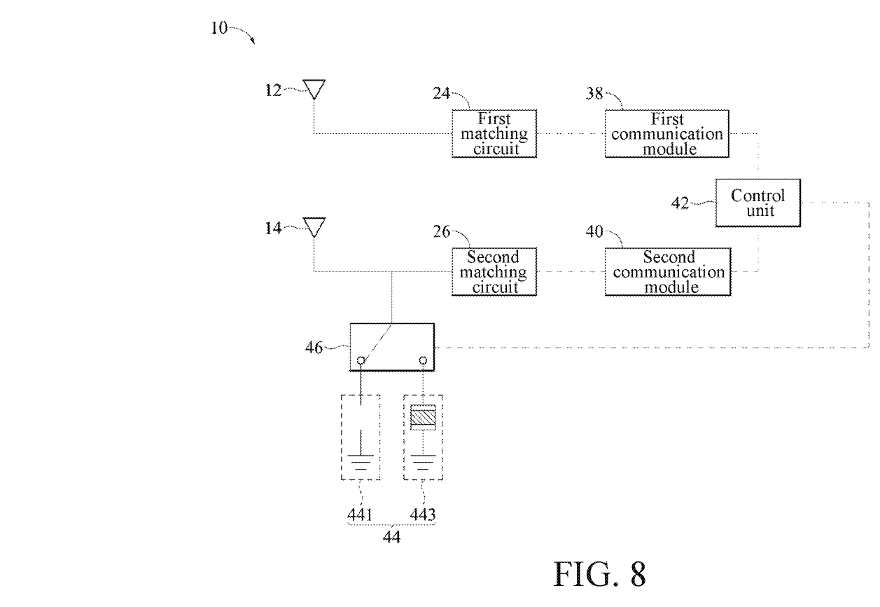

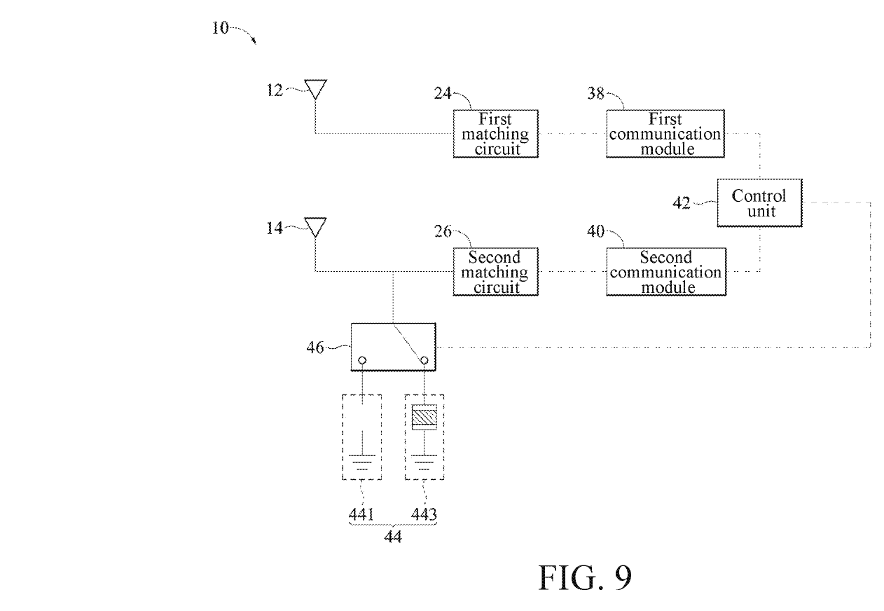

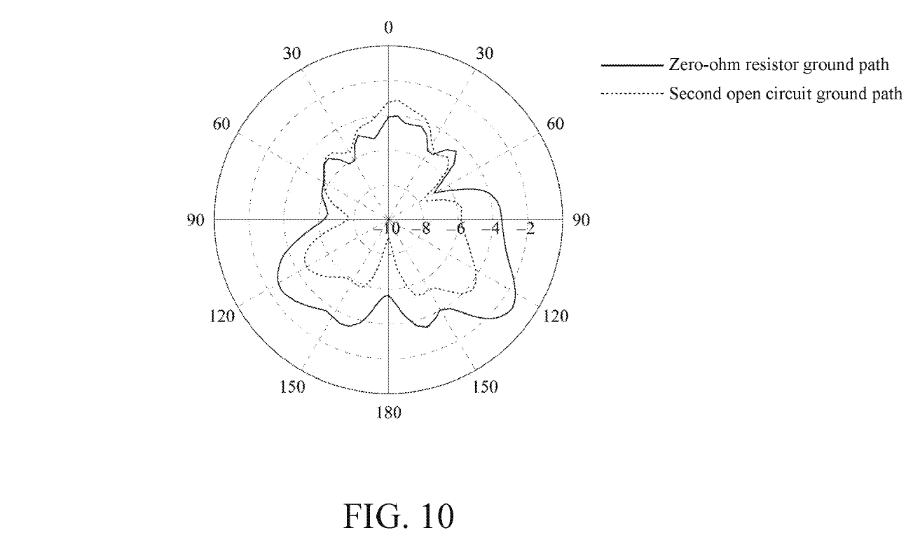

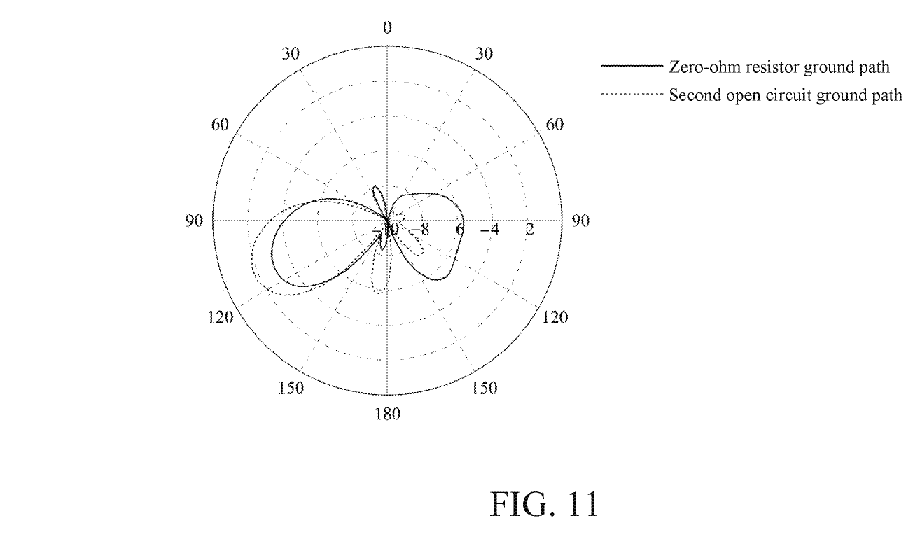

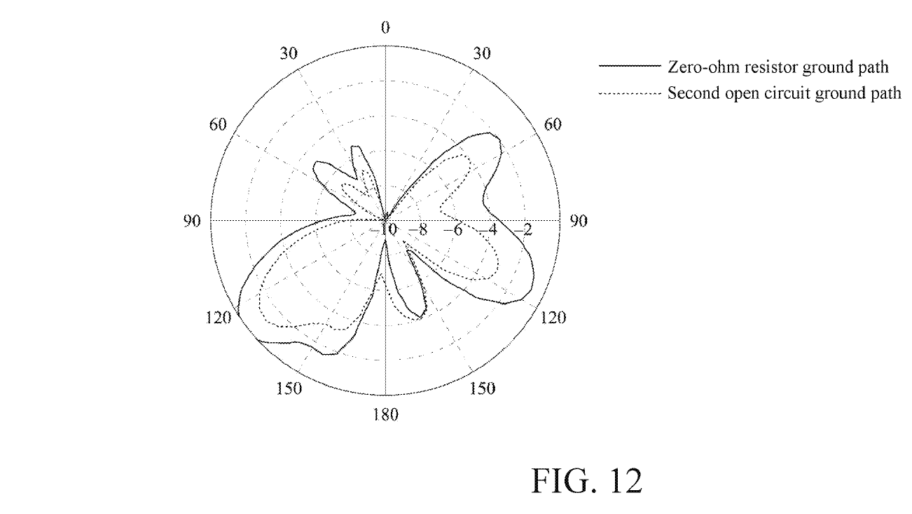

Next, an actual example of the antenna system 10 for optimizing an antenna pattern is described. An embodiment of optimizing the first antenna metal portion 12 shown in FIG. 3 and FIG. 4 is used as an example for detailed description. Refer to FIG. 7, FIG. 8, and FIG. 9. In this embodiment, the first communication module 38 used in the antenna system 10 is a wireless local area network (WLAN) communication module, and the first antenna metal portion 12 is a wireless local area network (WLAN) antenna, and supports frequency bands of 2400 MHz to 2500 MHz and 5150 MHz to 7125 MHz. When the second communication module 40 is a wireless wide area network (WWAN) communication module, the second antenna metal portion 14 is a wireless wide area network (WWAN) antenna, and supports a frequency band of 3300 MHz to 4200 MHz. In addition, in this embodiment, the first antenna metal portion 12 (wireless local area network antenna) is optimized, so that the second switch circuit 46 is configured on the second antenna metal portion 14. The second switch circuit 46 uses a single-pole double-throw (SPDT) switch. The single-pole double-throw switch is connected to two ground paths, that is, a second open circuit ground path 441 and a zero-ohm resistor ground path 443. When the first communication module 38 and the second communication module 40 are in operation simultaneously, the control unit 42 controls the second switch circuit 46 to selectively conduct the second feeding contact 18 to the second open circuit ground path 441, as shown in FIG. 8, to maintain normal operation of the first antenna metal portion 12 and the second antenna metal portion 14. When the second communication module 40 is disabled and the first communication module 38 is in operation, only a wireless local area network is supported in such an environment, and the control unit 42 controls the second switch circuit 46 to selectively conduct the second feeding contact 18 to the zero-ohm resistor ground path 443, as shown in FIG. 9, to change original impedance or an original current path of the first antenna metal portion 12, so as to change an antenna pattern of the first antenna metal portion 12. Refer to FIG. 10, FIG. 11, and FIG. 12. In the antenna system 10 with the second switch circuit 46 and the second ground path 44 added, there are two pattern types on an XY plane, an XZ plane, and a YZ plane, to effectively optimize an antenna pattern range.

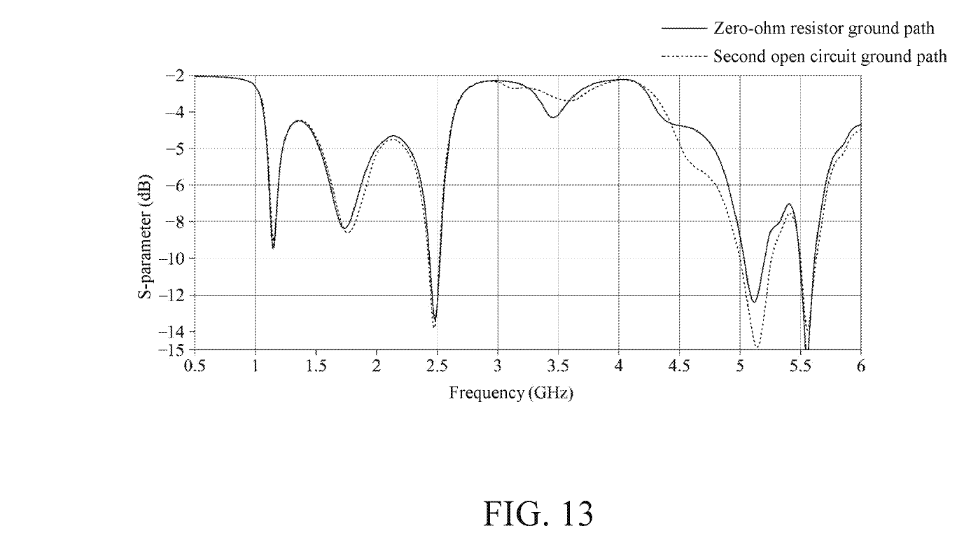

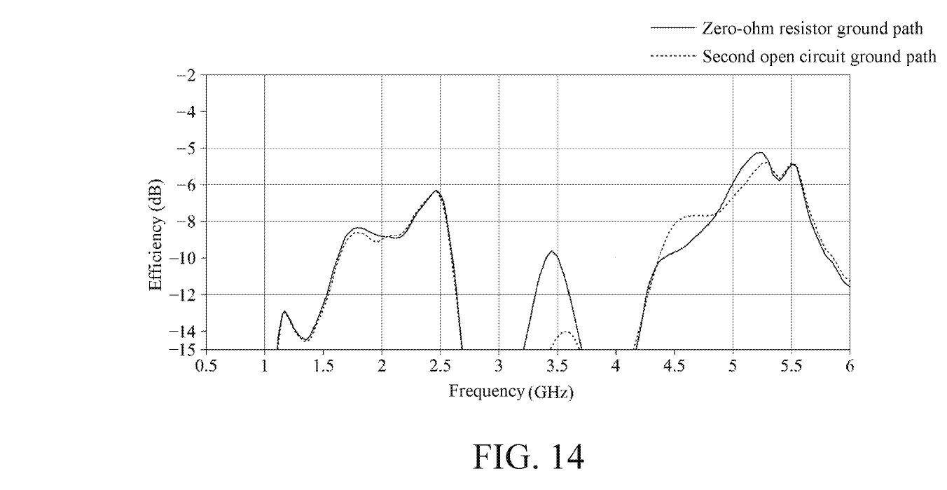

Furthermore, when the second switch circuit 46 selectively conducts either the second open circuit ground path 441 or the zero-ohm resistor ground path 443, the antenna system 10 performs S-parameter (a reflection coefficient curve S₁₁) and efficiency simulation analysis under the two conditions. Simulation results of the S-parameter and efficiency are shown in FIG. 13 and FIG. 14, respectively. As is learned from a reflection coefficient curve (S₁₁) shown in FIG. 13, regardless of whether the second open circuit ground path 441 or the zero-ohm resistor ground path 443 is switched to, reflection coefficient curves of the two perform well. As shown in an efficiency curve in FIG. 14, radiation efficiency at a Wi-Fi frequency band is above a specific level, performing well. Therefore, in the disclosure, the antenna pattern is adaptively optimized based on a current usage scenario and a signal status.

In summary, the disclosure provides the antenna system for optimizing an antenna pattern. In a limited and compact antenna design environment, impedance and a current path of an antenna are changed by switching the ground paths through the switch circuit, to dynamically switch the antenna pattern, and further to expand and enhance a range of the antenna pattern. Therefore, in the disclosure, an antenna reception range is increased and antenna performance is enhanced by optimizing the antenna pattern.

The embodiments described above are intended merely to describe the technical concepts and features of the disclosure. The purpose of the disclosure is to enable those familiar with this technology to understand content of the disclosure and implement the content accordingly. This should not be used to limit the scope of the patent of the disclosure. In other words, any equivalent changes or modifications made based on the spirit disclosed in the disclosure should still be included in the scope of the patent of the disclosure.

What is claimed is:

1. An antenna system for optimizing an antenna pattern, comprising:
a first antenna metal portion;
a second antenna metal portion, wherein a gap is between the first antenna metal portion and the second antenna metal portion, to cause an open circuit to be between the first antenna metal portion and the second antenna metal portion;
a first feeding contact, electrically connected to the first antenna metal portion;
a second feeding contact, electrically connected to the second antenna metal portion;
a first ground contact, electrically connected to the first antenna metal portion and farther away from the open circuit than the first feeding contact;
a second ground contact, electrically connected to the second antenna metal portion and farther away from the open circuit than the second feeding contact;
a first matching circuit, electrically connected to the first feeding contact;
a second matching circuit, electrically connected to the second feeding contact;
a plurality of first ground paths, connected to the first feeding contact; and
a first switch circuit, wherein one end of the first switch circuit is electrically connected between the first feeding contact and the first matching circuit, and the other end of the first switch circuit is electrically connected to the plurality of first ground paths to selectively conduct the first feeding contact to one of the plurality of first ground paths.

2. The antenna system for optimizing an antenna pattern according to claim 1, wherein the first matching circuit is further electrically connected to a first communication module, and the second matching circuit is further electrically connected to a second communication module.

3. The antenna system for optimizing an antenna pattern according to claim 2, wherein the plurality of first ground paths comprises an open circuit ground path and at least one passive component ground path.

4. The antenna system for optimizing an antenna pattern according to claim 3, wherein the at least one passive component ground path is selected from a zero-ohm resistor ground path, a resistor ground path, an inductor ground path, a capacitor ground path, or a resistor-inductor-capacitor combination ground path.

5. The antenna system for optimizing an antenna pattern according to claim 3, wherein the first switch circuit selectively conducts the first feeding contact to the open circuit ground path when the first communication module and the second communication module are in operation.

6. The antenna system for optimizing an antenna pattern according to claim 3, wherein the first switch circuit selectively conducts the first feeding contact to the passive component ground path, to change impedance or a current path of the second antenna metal portion to optimize an antenna pattern when the first communication module is disabled and the second communication module is in operation.

7. The antenna system for optimizing an antenna pattern according to claim 2, further comprising a plurality of second ground paths, connected to the second feeding contact; and a second switch circuit, wherein one end of the second switch circuit is electrically connected between the second feeding contact and the second matching circuit, and the other end of the second switch circuit is electrically connected to the plurality of second ground paths to selectively conduct the second feeding contact to one of the plurality of second ground paths.

8. The antenna system for optimizing an antenna pattern according to claim 7, wherein the plurality of first ground paths respectively comprises a first open circuit ground path and at least one first passive component ground path, and the plurality of second ground paths respectively comprises a second open circuit ground path and at least one second passive component ground path.

9. The antenna system for optimizing an antenna pattern according to claim 8, wherein the at least one first passive component ground path and the at least one second passive component ground path are respectively selected from a zero-ohm resistor ground path, a resistor ground path, an inductor ground path, a capacitor ground path, or a resistor-inductor-capacitor combination ground path.

10. The antenna system for optimizing an antenna pattern according to claim 8, wherein when the first communication module and the second communication module are in operation, the first switch circuit selectively conducts the first feeding contact to the first open circuit ground path, and the second switch circuit selectively conducts the second feeding contact to the second open circuit ground path.

11. The antenna system for optimizing an antenna pattern according to claim 8, wherein when the first communication module is disabled and the second communication module is in operation, the first switch circuit selectively conducts the first feeding contact to the first passive component ground path, to change impedance or a current path of the second antenna metal portion to optimize an antenna pattern; and when the first communication module is in operation and the second communication module is disabled, the second switch circuit selectively conducts the second feeding contact to the second passive component ground path, to change impedance or a current path of the first antenna metal portion to optimize an antenna pattern.

12. The antenna system for optimizing an antenna pattern according to claim 1, wherein the first switch circuit is a single-pole four-throw (SP4T) switch, at least one single-pole double-throw (SPDT) switch, or a plurality of single-pole single-throw (SPST) switches.

13. The antenna system for optimizing an antenna pattern according to claim 7, wherein the first switch circuit and the second switch circuit are respectively selected from a single-pole four-throw (SP4T) switch, at least one single-pole double-throw (SPDT) switch, or a plurality of single-pole single-throw (SPST) switches.
